(19) United States
(12) Patent Application Publication
(10) Pub. No.: US 2009/0142122 A1
(43) Pub. Date: Jun. 4, 2009

(54) Rotary Dispenser-Applicator For A Typically Solid Cosmetic Product

(76) Inventors: Alain Berhault, Paris (FR); Dorian Rosati, Taverny (FR)

Correspondence Address: BANNER & WITCOFF, LTD., TEN SOUTH WACKER DRIVE, SUITE 3000, CHICAGO, IL, 60606, US

(21) Appl. No.: 12/335,924

(22) Filed: Dec. 16, 2008

(30) Foreign Application Priority Data
Jun. 20, 2006 (FR) 06 05461

(51) Int. Cl. B43K 23/00

(52) U.S. Cl. 401/98; 401/137

(57) ABSTRACT

The dispenser-applicator (1) comprises a container (2) forming a cavity (20) and a block (3) of a cosmetic product (3′), in which:
a) said container (2) comprises a body (4) and a lid (5), said body (4) forming a first cavity (40), equipped with an edge (41), and said lid (5) forming a second cavity (50), said lid (5) cooperating with said edge (41) when said dispenser-applicator is closed, so that, when said dispenser-applicator is closed, a first part of said block (3) is housed in said first cavity (40) and a second part (31) of said block (3) is housed, above said edge (41), in said second cavity (50),
b) said block (3) and said body (4) cooperate by forming an interdependent unit (6) including a means of rotation (60) of said block (3) in relation to said body (4) along an axis of rotation (61), said means of rotation (60) including a first means of rotation (62) of said body (4) cooperating with a complementary means of rotation (63) of said block (3),
c) said block (3) and said second means of rotation (63) form a mobile revolving part (3a) with a rotation in relation to said body (4), of radius R1 of from 3 mm to 60 mm.
   Advantage: the possibility of obtaining different make-up effects by controlling and slowing down the rotation of said revolving part (3a).

### FIELD OF THE INVENTION

The invention relates to the field of cosmetic dispenser-applicators for cosmetics, and in particular for cosmetic in solid form or which are sufficiently consistent to appear in the form of a block such as, for example, in the case of lipsticks forming a stick and used in lipsticks tubes, or in the case of blocks of powder packed in make-up cases, or in the case of deodorant blocks.

### BACKGROUND OF RELATED ART

Many rotary applicators are already known, as described, for example, in French patent n^{o} 2.848.790 in the name of the applicant.

Many dispenser-applicators for liquid cosmetic products are also known, as described, for example, in French patent n^{o} 2 836 245 in the name of the applicant.

### PROBLEMS POSED

Firstly, in many cases, dispensers of solid cosmetic products, for example cases containing a block of packed powder, also include a means of application of the cosmetic, generally a tuft for make-up cases, so that gripping this tuft by hand to apply make-up generally leads to a certain soiling of the hands. There is therefore a need for dispensers which also allow the cosmetic to be applied without soiling the hands, as is already the case for lipstick tubes.

In addition, there is a need to obtain new make-up effects via new means of application. Moreover, it is often difficult to fully consume the cosmetic product, in particular because the dispenser, especially when it is a case containing a block of packed powder, forms a container with angular sections in which the cosmetic is difficult to reach with a tuft.

Finally, in the field of conditioning cosmetic products, there is a permanent need to renew the commercial offer of new products, in conjunction with functions or ergonomics that are advantageous for those using them.

### DESCRIPTION OF THE INVENTION

According to the invention, the dispenser-applicator comprises a container forming a cavity and a block of a typically solid cosmetic product, housed in said cavity.

In this dispenser-applicator:

a) said container includes a body and a lid, said body forming a first cavity, equipped with an edge, and said lid forming a second cavity (50), said lid cooperating with said edge when said dispenser-applicator is closed, so that, when said dispenser-applicator is closed, said block is housed in said cavity, a first part of said block being housed in said first cavity and a second part of said block being housed, above said edge, in said second cavity,
b) said block and said body cooperate by forming an interdependent unit including a means of rotation of said block in relation to said body along an axis of rotation, said means of rotation including a first means of rotation of said body cooperating with a complementary means of rotation of said block, forming at least one “hub-axle” couple of a male part and a female part,
c) said block and said complementary means of rotation form a mobile revolving part with a rotation of radius R1 of from 3 mm to 60 mm, so that, said dispenser being open, an application of said second part of said block on part of the human body, typically on the lips, with a sideways movement of said assembly in a direction perpendicular to said axis of rotation by gripping said body by hand, causes said block to rotate in relation to said body and therefore to deposit said cosmetic on said part of the human body.

This combination of means a) to c) according to the invention solves the problems posed.

Gripping said body by hand also ensures indirect control of the spatial position of said block, said block and said body cooperating to form an interdependent unit, so that said handling of said body does not lead to any direct contact between the hand that grips and said cosmetic, which removes any risk of soiling.

In addition, the dispenser-applicator according to the invention provides direct application of the cosmetic without the need for an applicator, with a special application movement, and with a revolving cosmetic product so as to deposit the cosmetic product on the surface to be made up, which obviously gives make-up effects different from those obtained with conventional conditionings.

Moreover, the means according to the invention enable the user to potentially consume the entire initial load of cosmetic product, so that said invention makes it possible to obtain a restitution rate close to 100%.

Finally, the invention makes it possible to renew the dispenser-applicator commercial offer, and above all to broaden the range of means available for conditioning solid cosmetic products.

### DESCRIPTION OF THE FIGURES

FIG. 1a is a side view of a dispenser-applicator (1) forming an open container (2), the lid (5) being separated from the body (4) and rotating interdependently with the block (3) of cosmetic product. This view is in a plane perpendicular to the axis of rotation (61). The body (4) comprises an edge (41) allowing the lid (5) to clip axially onto the body (4), with a shoulder forming a stop for the lid (5).

FIG. 1b is a perspective view for another dispenser method (1), said dispenser, as in FIG. 1a, forming an open container (2), with the lid (5) shown at a distance from, and opposite, the body (4).

FIG. 1c is a perspective view for another method of the invention and shows the interdependent unit (6) formed by the co-operation of said body (4) and said block (3). In this method, the body (4) includes a central reduced part so as to make it easier to grip said body (4) by hand.

FIG. 1d is a schematic cross-section along the transverse plane A-A of FIG. 1a, said transverse plane being perpendicular to the axial direction (10) of the dispenser-applicator (1) and parallel with the direction of the axis of rotation (61) of said interdependent unit (6). This view represents the concave-shaped block of cosmetic product in the dispenser-applicators of FIGS. 1b and 1c, surrounded of the edge (41) of the body (4).

FIG. 1e is a simplified representation of FIG. 1d in which said edge (41) has been shown by a single line.

FIGS. 2a to 2f pertain to the same dispenser-applicator (1) method.

FIG. 2a is a side view of the closed dispenser-applicator (1), internal parts being shown by dotted lines opposite FIG. 2b. FIG. 2a is a view along a vertical plane containing the large side or length of the dispenser-applicator (1), this plane being perpendicular to the axis of rotation (61).

FIG. 2b is a cross-section along axial plane B-B of FIG. 2a, perpendicular to the vertical plane of FIG. 2a.

FIG. 2c is a cross-section along plane C-C of FIG. 2a.

FIG. 2d is a cross-section along plane D-D of FIG. 2b.

FIG. 2e is a view of the top of the closed dispenser-applicator (1) in FIG. 2a.

FIG. 2f is a side view similar to that of FIG. 2a, but showing the dispenser-applicator open, the lid (5) having been turned over above the body (4), the lid containing internal projections (52a, 52b) forming half-axles guided by an axial groove (43) formed on said body (4). Said internal projection (52a) and said axial guide groove (43) have been shown in dotted lines, as in FIG. 2a, the internal projections (52a, 52b) being in “low” position in FIG. 2a and in “high” position in FIG. 2f.

FIGS. 3a to 3f pertain to the same dispenser-applicator (1) method.

FIG. 3a, similar to FIG. 2f, is a side view of the open dispenser-applicator (1), lid (5) having been swung to one side by means of the hinge (23) of the container (2).

FIG. 3b, similar to FIG. 2a, is a side view which shows the dispenser-applicator closed.

FIG. 3d, similar to FIG. 2b, is an axial cross-section along plane B-B of FIG. 3b

FIG. 3e, similar to FIG. 2c, is an axial cross-section along plane C-C of FIG. 3b.

FIG. 3c, similar to FIG. 2d, is an axial cross-section along plane D-D of FIG. 3d.

FIG. 3f similar to FIG. 2e is a view of the top of the closed dispenser-applicator (1) in FIG. 3b. The revolving part (3a) with block (3) and its axis of rotation (61) have been shown in dotted lines.

FIGS. 4a to 4d represent various methods of means of complementary rotation (63) for the revolving parts (3a) shown in cross section along the axis of rotation (61).

In FIG. 4a, the complementary means of rotation (63) include two male parts opposite each other (640) and (640′).

In FIG. 4b, the complementary means of rotation (63) include a male part (640″) passing right through block (3).

In FIG. 4c, the complementary means of rotation (63) include a female part (641″) passing right through block (3).

In FIG. 4d, the complementary means of rotation (63) include two female parts opposite each other (641) and (641′).

FIGS. 4e to 4g are cross-sections similar to those of FIGS. 4a to 4d, which represent the case where, as already illustrated in FIGS. 2b, 2c, 3d and 3e, said body (4) includes an intermediate support (8) bearing said means of rotation (62).

FIG. 4e represents, as an axial cross-section, revolving part (3a) including said block (3) and a male part (640″) forming an axle, cooperating with the left-hand part (81) of said support (8), its right-hand part (80) being opened out by means of a narrowed part (82′) forming a means of opening out (82).

FIG. 4f shows support (8) interdependent with revolving part (3a), after folding back the right-hand part (80) of support (8), the right-hand (80) and left-hand (81) parts containing blind holes (800, 810) cooperating with the ends of axle (640″), so as to form said hub-axle couple (64).

FIG. 4g represents support (8) in FIG. 4f assembled onto said body (4), typically by clipping.

FIGS. 5a to 5d illustrate revolving parts (3a) including blocks (3) of various shapes in conjunction with an axle (640″), as an axial cross-section along said axis of rotation (61).

FIG. 5a represents said interdependent unit (6), shown as an axial cross-section, with block (3) positioned ready to apply said cosmetic product (3′) to the lips (70, 7).

This unit comprises a revolving part (3a) with a block (3) of low transverse thickness E in relation to radius R1 of said revolving part, so as to permanently offer a surface of application of low relative thickness.

Two arrows are used to show both manual gripping of said body (4) and the means of slowing down rotation of said revolving part (3a) by exerting manual pressure on the edge of the body (4) against the ends of the axle (640″).

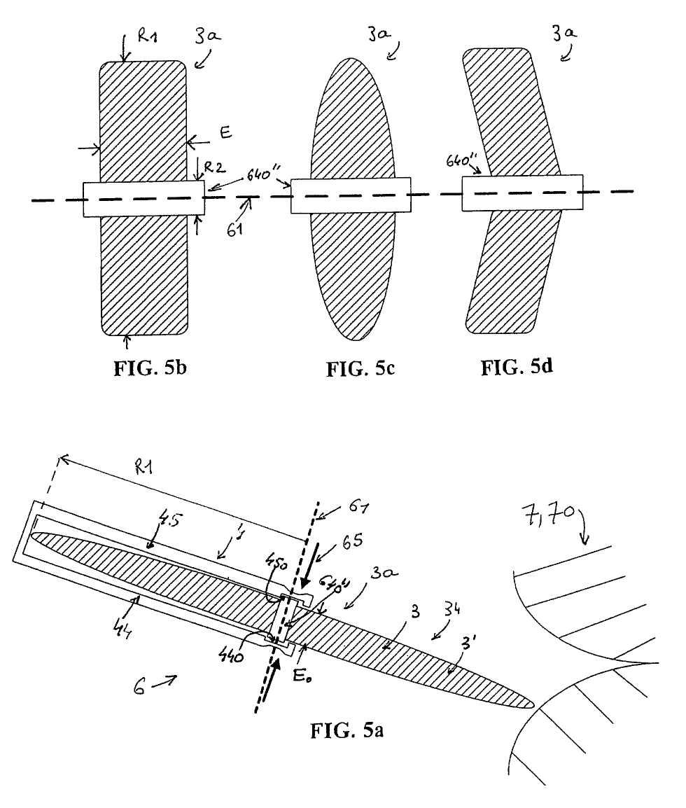

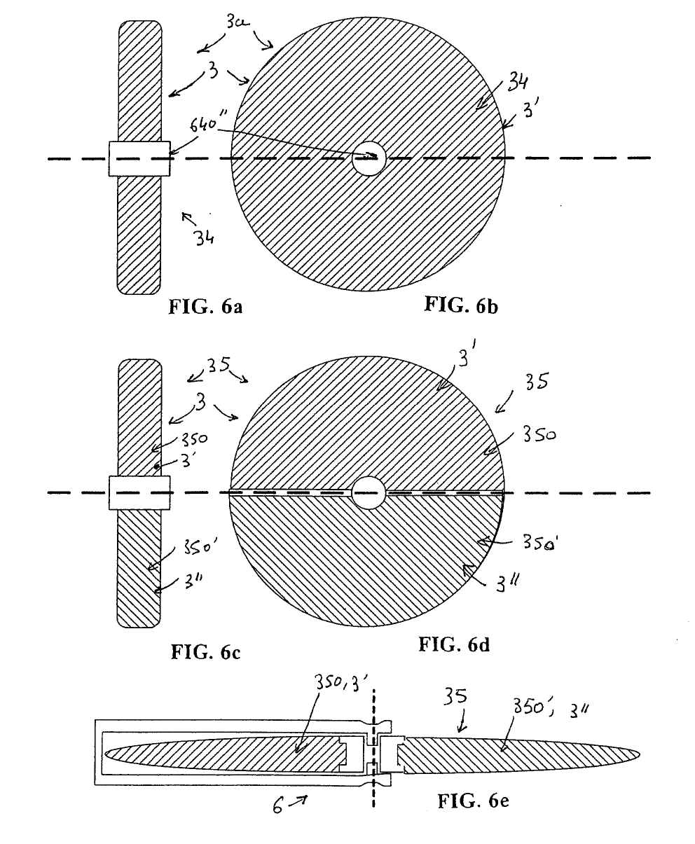

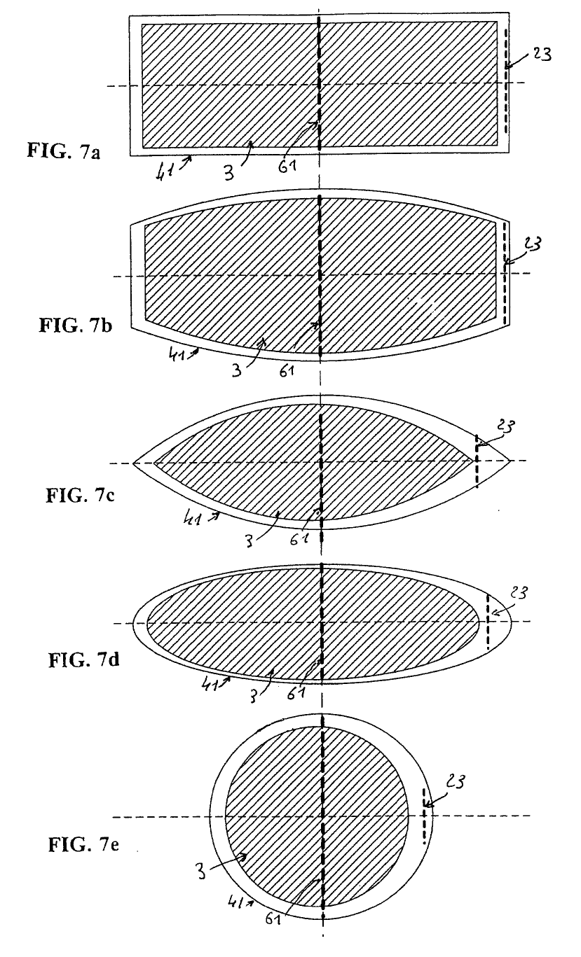

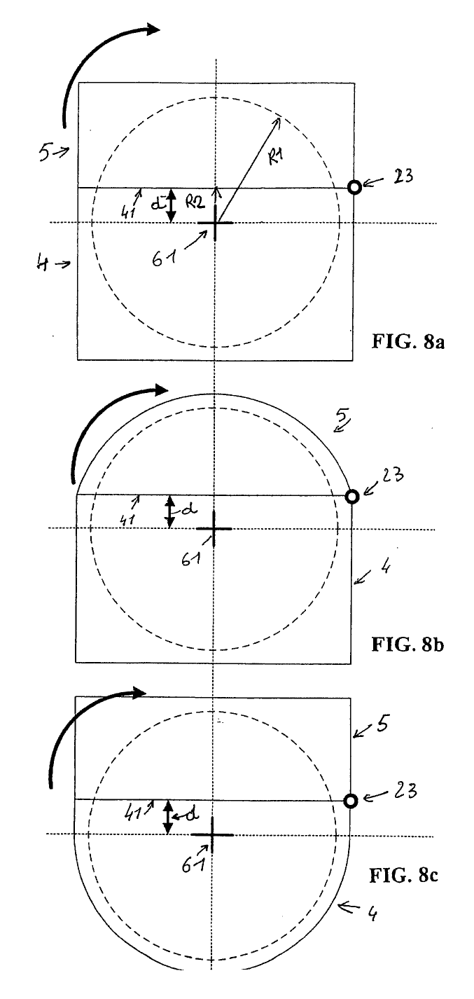

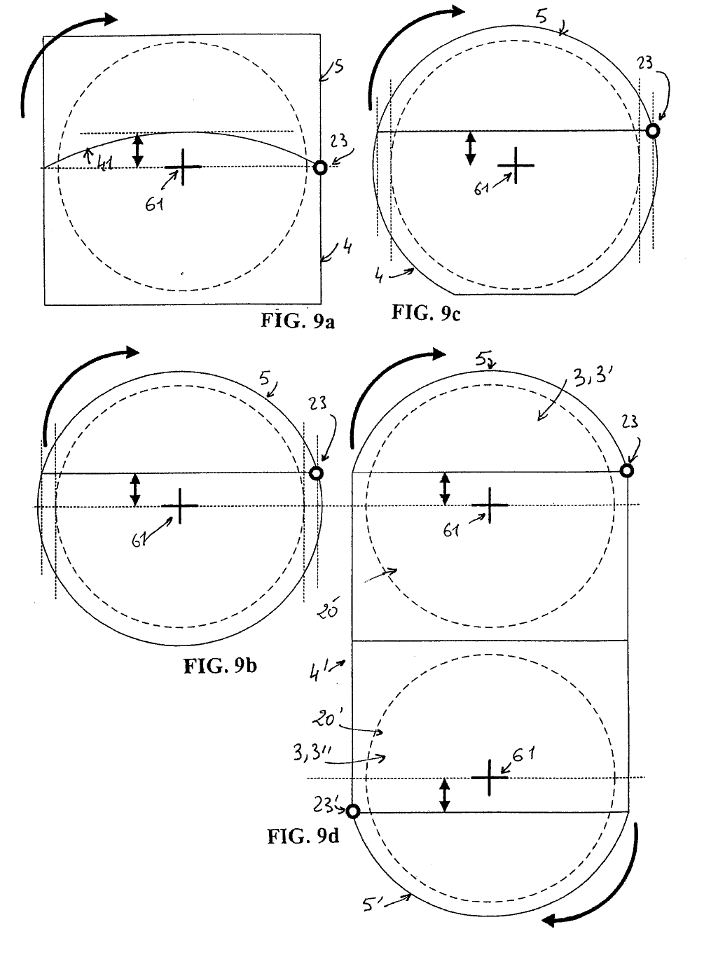

In FIG. 5b, said block (3) is rectangular in section.

In FIG. 5c, said block (3) is oval in section.

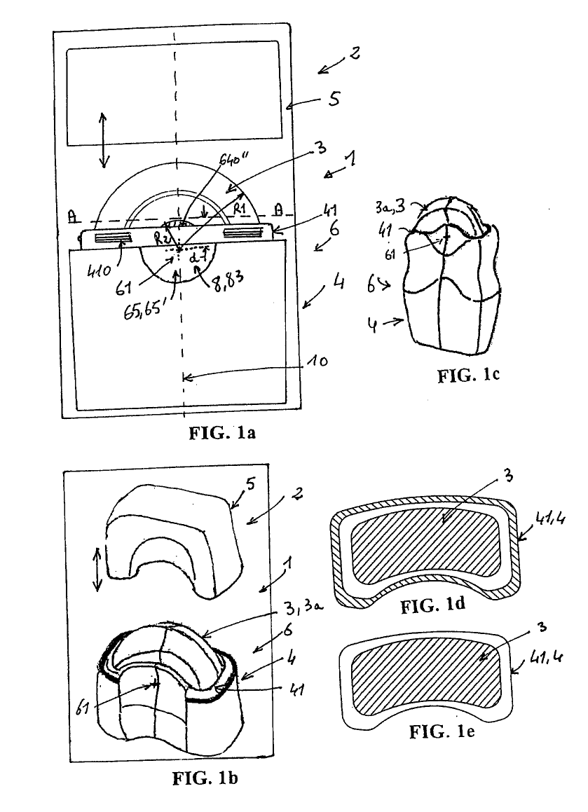

In FIG. 5d, said block (3) has a section with a concave part opposite a convex part, which can be used if said body (4) also has a hollow part, as illustrated in FIG. 1b for example.

FIGS. 6a to 6e are similar to FIGS. 5a to 5d and illustrate other methods for revolving parts (3a).

FIG. 6a is similar to FIG. 5b, but with a block (3) with a different R1/E ratio, said block (3) forming a homogeneous block (34) of the same cosmetic product (3′).

FIG. 6b is a side view of the revolving part (3a) of FIG. 6a.

FIGS. 6c and 6d are similar to FIGS. 6a and 6b respectively, but differ from them in that said block (3) is a heterogeneous block (35) made up of two distinct blocks (350, 350′) corresponding to two distinct cosmetic products (3′, 3″).

FIG. 6e represents the unit (6) in FIG. 5a, but with a heterogeneous block (35) instead of a homogeneous block (34), each block (350, 350′) extending typically over the same angular fraction of 180°.

FIGS. 7a to 7e are similar to FIG. 1e and illustrate schematically various shapes for the bodies (4) in conjunction with various shapes of blocks (3), with homothetic sections. Dotted lines are used to show the axes of rotation (61) as well as the hinges (23) joining the lids (5) to the bodies (4), said hinges (23) typically being directed parallel to the axes of rotation (61).

In FIG. 7a, the sections of the body (4) and the block (3) are rectangular.

In FIG. 7b, the sections of the body (4) and the block (3) form two non-planar walls opposite each other.

In FIG. 7c, the sections of the body (4) and the block (3) form two non-planar walls connected to each other.

In FIG. 7d, the sections of the body (4) and the block (3) are oval.

In FIG. 7e, the sections of the body (4) and the block (3) are round.

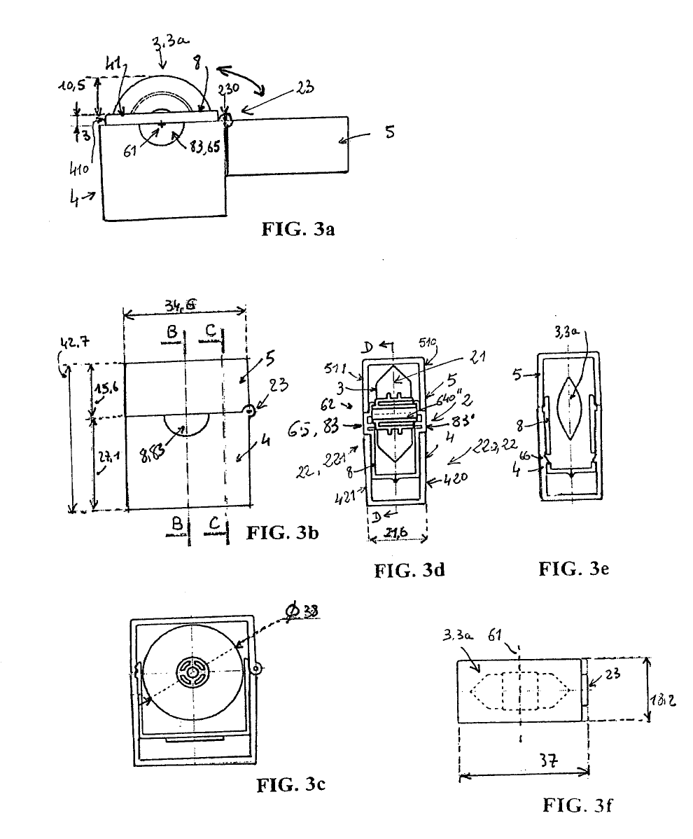

FIGS. 8a to 8c are side views of closed dispenser-applicators (1), shown similarly to FIG. 3b.

In FIG. 8a, both the lid (5) and the body (4) have quadrangular-shaped, typically rectangular-shaped side walls.

In FIG. 8b, the lid (5) is semicircular in shape, homothetic with the shape of the block (3).

In FIG. 8c, the body (4) is semicircular in shape, homothetic with the shape of the block (3).

FIGS. 9a to 9d illustrate other alternatives for closed dispenser-applicators (1) similar to FIGS. 8a to 8c.

In FIG. 9a, the edge (41) is not a plane but curved.

In FIG. 9b, said dispenser-applicator (1) is substantially spherical in shape.

In FIG. 9c, said dispenser-applicator (1) has the shape of truncated sphere, said body (4) including a planar support part.

In FIG. 9d, said dispenser-applicator (1) is a double dispenser-applicator including a double body (4′) defining two cavities (20, 20′) housing two blocks (3) of distinct cosmetic products (3′, 3″).

### DETAILED DESCRIPTION OF THE INVENTION

As illustrated for example in FIGS. 8a to 8c, said complementary means of rotation (63) of said block (3) has a radius R2 that is lower than R1, typically lower than 0.5.R1, said axis of rotation (61) being placed at a distance d from said edge (41) typically equal to R2, so as to allow all of said block (3) of cosmetic product to be applied, said block (3) having a radial thickness typically equal to R1−R2.

Radius R2 may be slightly higher than distance d as illustrated for example in FIG. 1a.

According to the invention, said block (3) may have a transverse thickness E, along a direction parallel to said axis of rotation (61), of from 3 mm to 25 mm, and typically from 5 mm to 15 mm. Said block (3) may have a transverse thickness E that can be lower in proportion to this block's (3) ability to remain whole, without being destroyed, a low relative thickness being possibly desirable for make-up purposes.

As illustrated for example in FIGS. 1b, 2b, 3d, said transverse thickness E may vary typically with distance R to said axis of rotation (61), said thickness E decreasing in proportion to distance R.

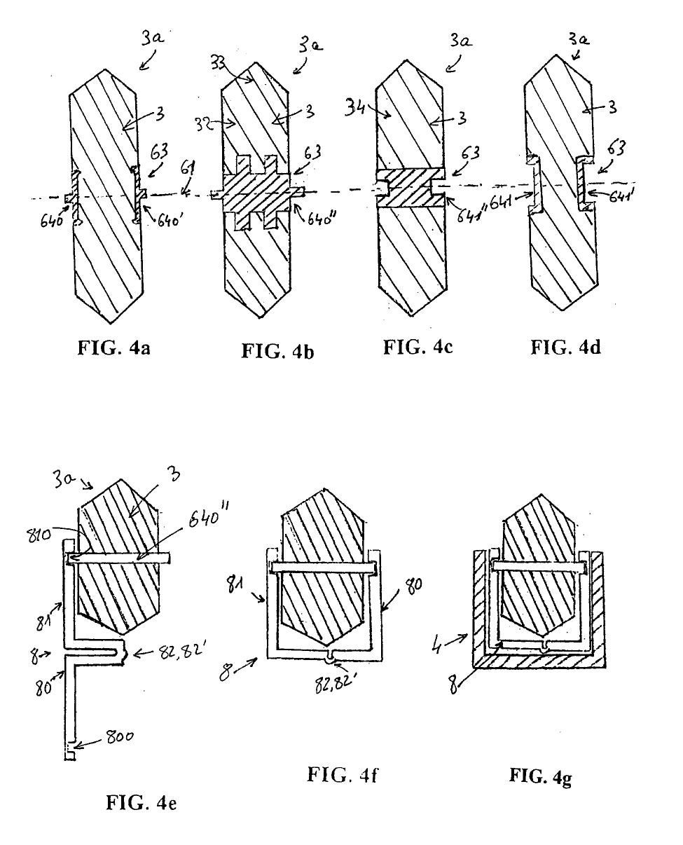

As illustrated for example in FIG. 4b, said block (3) may include a central part (32) of transverse thickness E_{C} that is typically constant, and a peripheral part (33) of which the thickness E_{P}<E_{C} decreases gradually, so as to form a block (3) with a tapered edge.

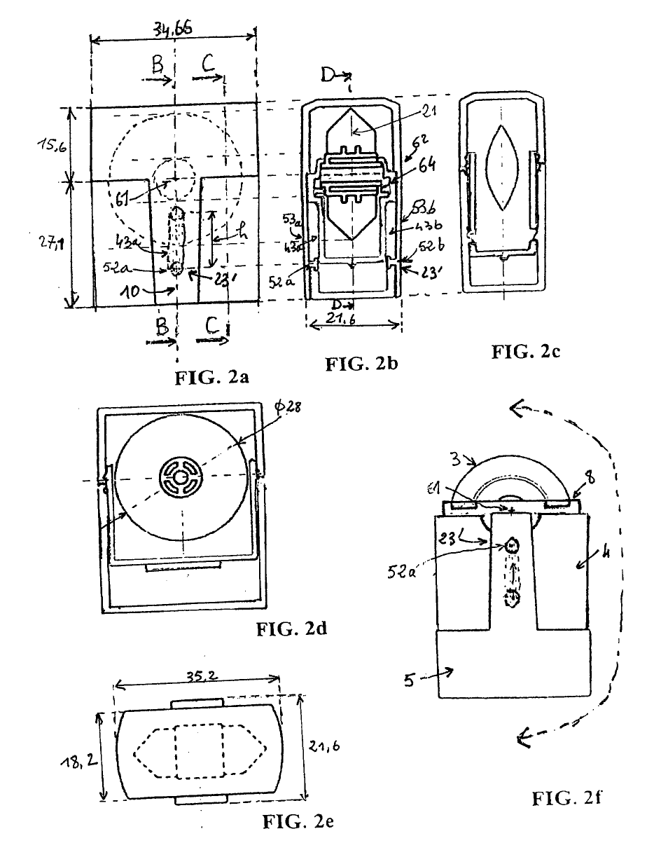

As illustrated in FIGS. 2b and 3d, said container (2) may have a plane of symmetry (21), said plane of symmetry (21) being perpendicular to said axis of rotation (61). However, such a plane of symmetry may be lacking in certain methods as illustrated in FIGS. 1b and 1c.

Typically, and as illustrated in FIG. 3d, said container (2) may comprise two side walls (22), a right-hand wall (220) and a left-hand wall (221), said right-hand (220) and left-hand (221) walls being spaced by a width L>E, so as to form said cavity (20) for said block (3), said right-hand wall (220) being formed by a first right-hand wall (420) of said body (4) and by a second right-hand wall (510) of said lid (5), said left-hand wall (221) being formed by a first left-hand wall (421) of said body (4) and a second left-hand wall (511) of said lid (5).

Said right-hand (220) and left-hand (221) walls may be laid out symmetrically in relation to a plane of symmetry (21) perpendicular to said axis of rotation (61).

As illustrated in particular in FIGS. 7a to 7e, said edge (41) of said body (4) and said block (3) may be of homothetic shape, so that said block (3), possibly guided by said edge (41), occupies typically at least 50% of the volume of said cavity (20).

According to one method of the invention, said means of rotation (62) of said body (4) includes two male sections or parts (641) opposite each other, cooperating with at least one female section or part (641, 641′, 641″) of said complementary means of rotation (63), so as to form said “hub-axle” (64) couple. FIGS. 4c and 4d show two methods for female parts (641, 641′, 641″) of said complementary means of rotation (63).

According to another method of the invention, illustrated in particular in FIGS. 2b, 3d, 5a and 6e, said means of rotation (62) of said body (4) may include two female sections or parts (641) opposite each other, cooperating with at least one male part (640, 640′, 640″) of said complementary means of rotation (63), so as to form said “hub-axle” (64) couple. FIGS. 4c and 4d show two methods for male parts (640, 640′, 640″) of said complementary means of rotation (63).

As illustrated in FIGS. 4a and 4d, said two male parts or said two female parts may form distinct parts opposite each other (640, 640′, 641, 641′) or one-piece parts (640″, 641″).

As illustrated in FIG. 1a, said lid (5) and said body (4) may form two distinct parts, said lid (5) and said body (4), typically said edge (41) of said body (4), including a means of axial clipping.

As illustrated in particular in FIG. 3a, said lid (5) and said body (4) may cooperate via a hinge (23), said hinge having an axis (230) typically parallel to said axis of rotation (61).

As illustrated in FIGS. 2a, 2b and 2f, said hinge (23) may be a hinge (23′) of variable height, typically via a guide groove (43), so that said lid (5) can be swung under said body (4) when said dispenser-applicator (1) is open, said lid (5) being then typically a continuation of said body (4).

According to another method of the invention, illustrated in FIGS. 1a, 2a to 3f and 4g, said body (4) may include an intermediate support (8) equipped with said means of rotation (62) of said body (4), said intermediate support (8) being interdependent with said body (4), typically by means of an axial clipping system.

As illustrated for example in FIGS. 4e to 4g, said intermediate support (8) may include a right-hand part (80) and a left-hand part (81) equipped with a means of spacing (82, 82′) so as to be able to assemble said block (3), typically said block (3a) equipped with said complementary means of rotation (63) to said intermediate support (8). The means of spacing (82) may be formed by a narrowed part (82′) of the intermediate support forming a hinge.

Advantageously, and according to the invention, the dispenser-applicators (1) according to the invention may include a means for slowing down (65) the rotation of said revolving part by manual pressure exerted at the level of said hub-axle couple.

In the special case where said interdependent unit (6) includes an intermediate support (8), and as illustrated in FIGS. 1a, 3a, 3b and 3d, said intermediate support (8) may include at least one so-called external part (83, 83′) forming said means of rotation (62), so as to form, by manual pressure on said external part (83, 83′), said means of slowing down (65, 65′) said revolving part (3a).

According to one method of the invention, and as illustrated in particular in FIGS. 6a and 6b, said block (3) may be a homogeneous block (34) made up of only one cosmetic product (3′).

According to another method of the invention, and as illustrated as a nonrestrictive example in FIGS. 6c to 6e, said block (3) may be a heterogeneous block (35) including at least two cosmetic products (3′, 3″) forming two distinct blocks (350, 350′).

Another subject of the invention is the use of a dispenser-applicator according to the invention for conditioning a block of selected cosmetic product chosen from: a lipstick, a compacted make-up powder, a deodorant.

### EXAMPLES OF EMBODIMENTS

All the figures are examples of embodiments of dispenser-applicators (1) or elements of dispenser-applicators according to the invention.

A) The dispenser-applicator (1) shown in FIG. 1a was manufactured. This dispenser is similar to that shown in FIGS. 3a to 3f and differs from it by the absence of a hinge (23), the lid (5) being reversibly clipped onto the edge (41) equipped with a means of clipping (410).

The interdependent unit (6) includes:
a revolving part (3a) according to FIG. 3d, formed by assembling a block (3) of cosmetic product onto a male part (640″) forming an axle
an intermediate support (8) including an external part (83) forming said complementary means of rotation (63), in the form of two half-hubs (641, 641′),
a body (4),
a lid (5)

The revolving part (3a) is initially assembled to the intermediate support (8) by opening out its side walls.

This “intermediate support (8)+revolving part (3a)” unit is then clipped into the body (4), as shown in FIG. 3e, the intermediate support (8) including a cut-out part cooperating with an internal radial projection of the body (4) to form a means of clipping (66), as shown in FIG. 3e.

In this example, as in the succeeding ones, the following were formed by plastic molding: the lid (5), the body (4), the intermediate support (8) and the complementary means of rotation (63) associated with said block (3) to form said revolving part (3a).

B) The dispenser-applicators (1) shown in FIGS. 1b and 1c were manufactured.

These dispensers (1) do not include an intermediate support (8), and once the revolving part (3a) has been formed it is forced into the body (4) including said means of rotation (62), so as to form by clipping said means of rotation (60) with said axis of rotation (61).

C) The dispenser (1) shown in FIGS. 2a to 2f was manufactured.

This dispenser is very similar to that shown in FIG. 1a, and in FIGS. 3a to 3f. It differs from it in particular in that the lid (5) includes two parallel lower projections (53a, 53b) which have, substantially at their base, internal projections forming a half-axle (52a, 52b) that can move in axial grooves (43a, 43b), so as to be able to swing said lid (5) under said body (4) when said dispenser-applicator (1) is open, said lid (5) being then typically a continuation of said body (4).

To achieve this, from the closed dispenser (1) shown in FIG. 2a, an upwards axial tension is first exerted on the lid (5) to make it move from the low and closed position to the high and open position, distant by height h, as shown in FIG. 2a All that is then required is to swing the lid (5) in relation to the body (4), as illustrated in FIG. 2f, to have the lid (5) placed below the body (4), which increases by the same amount the means of manual gripping of the body (4) thereby improving the ergonomics of the application.

D) The dispenser (1) shown in FIGS. 3a to 3f was manufactured.

This dispenser is very similar to that of FIG. 1a and differs from it by the presence of a hinge (23) making the lid (5) interdependent with the body (4).

A variant in which the lid is made interdependent with the intermediate support (8) was also manufactured.

E) With regard to the manufacture of the revolving parts (3a), all kinds of variants were manufactured, as illustrated in FIGS. 4a to 5d.

F) Relatively thin dispensers (1) were also manufactured, with a ratio R1/E₀, E₀ being the transverse width of the block (3) at its base at the level of said complementary means of rotation (63), typically greater than 3, or even 5, as illustrated in FIGS. 5a and 6e.

G) Dispensers (1) were also manufactured with various types of blocks (3), from the standpoint of both their geometrical form and their composition, as illustrated in FIGS. 1b, 1c, 2b, 4a to 4d, 5b to 6e, 7a to 7e. These blocks (3) were blocks of lipsticks, compacted powders, and deodorants.

H) Various variants of the dispenser (1) were also manufactured as shown in FIGS. 3a to 3f, varying the shape of the lid (5) and/or the body (4), as illustrated in FIGS. 8a to 9d.

### ADVANTAGES OF THE INVENTION

The invention makes it possible to considerably renew dispenser-applicators (1) from the standpoint of their structure, ergonomics, and the movements involved in applying products.

With these dispenser-applicators (1), the cosmetic product is deposited by rotation of a block (3) of the product itself, manual gripping of the body (4) making it possible, by means of manual pressure on the edge of the body (4), to control the rotation of the block (3), and if required to stop it in order to obtain various make-up effects.

### LIST OF REFERENCE NUMBERS

Dispenser-applicator . . . 1
   Axial direction . . . 10
Container . . . 2
   Cavity . . . 20, 20′
   Plane of symmetry . . . 21
   Side walls . . . 22
      Right-hand wall . . . 220
      Left-hand wall . . . 221
   Hinge between 4 and 5 . . . 23, 23′
      Hinge pin . . . 230
Block of cosmetic product . . . 3
Cosmetic product . . . 3′
Revolving part=3+63 . . . 3a
   First part of the block housed in 40 . . . 30
   Second part of the block housed in 50 . . . 31
   Central part 32
   Peripheral part 33
   Homogeneous block . . . 34
   Heterogeneous block . . . 35
      Distinct 35 blocks . . . 350, 350′
Body of 2 4
   First cavity . . . 40
   Edge . . . 41
      Means of clipping on the lid . . . 410
   First wall . . . 42
      First right-hand wall . . . 420
      First left-hand wall . . . 421
   Axial guide groove for the lid . . . 43a, 43b
   Right-hand wall . . . 44
      Blind hole . . . 440
   Left-hand wall . . . 45
      Blind hole . . . 450
Lid of 2 5
   Second cavity . . . 50
   Second wall . . . 51
      Second right-hand wall . . . 510
      Second left-hand wall . . . 511
   Internal projection forming a half-axle . . . 52a, 52b
   Lower projections 53a, 53b
Interdependent unit made up of 3a & 4 (& 8) . . . 6
   Means of rotation of 2 in relation to 4 . . . 60
   Axis of rotation . . . 61
   Means of rotation of body 4 or support 8 . . . 62
   Complementary means of rotation of 3a. 63
   Hub-axle couple . . . 64
      Male part 640, 640′, 640″
      Female part 641, 641′, 641″
   Means of braking of 3a 65
   Means of clipping of 4 and 8 66
Part of the human body . . . 7
   Lips . . . 70
Intermediate support . . . 8
   Right-hand part . . . 80
      Blind hole forming 641 . . . 800
   Left-hand part . . . 81
      Blind hole forming 641 . . . 810
   Means of spacing of 80 and 81 82
   Narrowed part . . . 82′
   External part forming a brake . . . 83

1. Dispenser-applicator (1) including a container (2) forming a cavity (20) and a block (3) of a typically solid cosmetic product (3′), placed in said cavity (20), in which:
a) said container (2) includes a body (4) and a lid (5), said body (4) forming a first cavity (40), equipped with an edge (41), and said lid (5) forming a second cavity (50), said lid (5) cooperating with said edge (41) when said dispenser-applicator is closed, so that, when said dispenser-applicator is closed, said block (3) is housed in said cavity (20), a first part (30) of said block (3) being housed in said first cavity (40) and a second part (31) of said block (3) being housed, above said edge (41), in said second cavity (50),
b) said block (3) and said body (4) cooperate by forming an interdependent unit (6) including a means of rotation (60) of said block (3) in relation to said body (4) along an axis of rotation (61), said means of rotation (60) including a first means of rotation (62) of said body (4) cooperating with a complementary means of rotation (63) of said block (3), forming at least one “hub-axle” couple (64) made of a male part (640) and a female part (641),
c) said block (3) and said complementary means of rotation (63) form a mobile revolving part (3a) with a rotation, in relation to said body (4), of radius R1 of from 3 mm to 60 mm, so that, said dispenser (1) being open, an application of said second part (31) of said block on a part (7) of the human body, typically on the lips (80), with a sideways movement of said assembly (6) in a direction perpendicular to said axis of rotation (60) by gripping said body by hand (4), causes said revolving part (3a) and said block (3) to rotate in relation to said body (4) and therefore to deposit said cosmetic product (3′) on said part (8) of the human body.

2. A dispenser-applicator according to claim 1 in which said complementary means of rotation (63) of said block (3) has a radius R2 lower than R1, typically lower than 0.5.R1, said axis of rotation (61) being placed at a distance d from said edge (41) typically equal to R2, so as to allow all said block (3) of cosmetic product to be applied, said block (3) having a radial thickness typically equal to R1−R2.

3. A dispenser-applicator according to claim 1 in which said block (3) has a transverse thickness E along a direction parallel to said axis of rotation (61), of from 3 mm to 25 mm, and typically from 5 mm to 15 mm.

4. A dispenser-applicator according to claim 3 in which said transverse thickness E varies typically with distance R to said axis of rotation (61).

5. A dispenser-applicator according to claim 4 in which said block (3) may include a central part (32) of transverse thickness E_{C} that is typically constant, and a peripheral part (33) of which the thickness E_{P}<E_{C} decreases gradually, so as to form a block (3) with a tapered edge.

6. A dispenser-applicator according to claim 1 in which said container (2) has a plane of symmetry (21), said plane of symmetry (21) being perpendicular to said axis of rotation (61)

7. A dispenser-applicator according to claim 1 in which said container (2) includes two side walls (22), a right-hand wall (220) and a left-hand wall (221), said right-hand (220) and left-hand (221) walls being spaced by a width L>E, so as to form said cavity (20) for said block (3), said right-hand wall (220) being formed by a first right-hand wall (420) of said body (4) and by a second right-hand wall (510) of said lid (5), said left-hand wall (221) being formed by a first left-hand wall (421) of said body (4) and a second left-hand wall (511) of said lid (5).

8. A dispenser-applicator according to claim 7 in which said right-hand (220) and left-hand (221) walls are laid out symmetrically in relation to a plane of symmetry (21) perpendicular to said axis of rotation (61).

9. A dispenser-applicator according to claim 1 in which said edge (41) of said body (4) and said block (3) are of homothetic shape, so that said block (3), possibly guided by said edge (41), typically occupies at least 50% of the volume of said cavity (20).

10. A dispenser-applicator according to claim 1 in which, said means of rotation (62) of said body (4) includes two male sections or parts (641) opposite each other, cooperating with at least one female section or part (641, 641′, 641″) of said complementary means of rotation (63), so as to form said “hub-axle” (64) couple.

11. A dispenser-applicator according to claim 1 in which, said means of rotation (62) of said body (4) includes two male sections or parts (641) opposite each other, cooperating with at least one female section or part (640, 640′, 640″) of said complementary means of rotation (63), so as to form said “hub-axle” (64) couple.

12. A dispenser-applicator according to claim 1 in which said two male parts or said two female parts may form distinct parts opposite each other (640, 640′, 641, 641′) or one-piece parts (640″, 641″).

13. A dispenser-applicator according to claim 1 in which said lid (5) and said body (4) form two distinct parts, said lid (5) and said body (4), typically said edge (41) of said body (4), including means of axial clipping.

14. A dispenser-applicator according to claim 1 in which said lid (5) and said body (4) cooperate via a hinge (23), said hinge having an axis (230) typically parallel to said axis of rotation (61).

15. A dispenser-applicator according to claim 14 in which said hinge (23) is a hinge (23′) of variable height, typically by virtue of a guide groove (43a, 43b), so that said lid (5) can be swung under said body (4) when said dispenser-applicator (1) is open, said lid (5) being then typically a continuation of said body (4).

16. A dispenser-applicator according to claim 1 in which said body (4) includes an intermediate support (8) equipped with said means of rotation (62) of said body (4), said intermediate support (8) being interdependent with said body (4), typically by means of an axial clipping system.

17. A dispenser-applicator according to claim 16 in which said intermediate support (8) includes a right-hand part (80) and a left-hand part (81) equipped with a means of spacing (82, 82′) so as to be able to assemble said block (3), typically said block (3a) equipped with said complementary means of rotation (63) to said intermediate support (8).

18. A dispenser-applicator according to claim 1 including a means of slowing down (65) the rotation of said revolving part by manual pressure exerted at the level of said hub-axle couple.

19. A dispenser-applicator according to claim 17 in which said intermediate support (8) includes at least one external part (83, 83′) forming said means of rotation (62), so as to form, by manual pressure on said external part (83, 83′) a means of slowing down (65, 65′) said revolving part (3a)

20. A dispenser-applicator according to claim 1 in which said block (3) is a homogeneous block (34) made up of only one cosmetic product (3′).

21. A dispenser-applicator according to claim 1 in which said block (3) is a heterogeneous block (35) including at least two cosmetic products (3′, 3″) forming two distinct blocks (350, 350′).
